(19) United States
(12) Patent Application Publication
(10) Pub. No.: US 2009/0326953 A1
(43) Pub. Date: Dec. 31, 2009

(54) Method of accessing cultural resources or digital contents, such as text, video, audio and web pages by voice recognition with any type of programmable device without the use of the hands or any physical apparatus.

(75) Inventors: Alonso J. Peralta Gimenez, (US); Elisabet Monita Castro, (US)

Correspondence Address: Ladas & Parry, 26 West 61st Street, New York, NY, 10023, US

(73) Assignee: MEIVOX, LLC.

(21) Appl. No.: 12/215,310

(22) Filed: Jun. 26, 2008

(51) Int. Cl. G10L 11/00

(52) U.S. Cl. 704/270.1; 704/E15.001

(57) ABSTRACT

The use of voice as a means of communication with a computer or programmable device (117), as well as, converting text to speech, allows visually or physically disabled people access to texts in any format such as, but not limited to, newspapers, books, Blogs, or web pages accessible through the Internet or other means of communication with their device (117) or computer. Likewise, users are enabled to access other cultural content such as movies, documentaries, music, etc. The invention also allows non-disabled people access to the same, in conditions that prevent them from using their hands, such as driving, or being outside their normal place to live or work.

### BACKGROUND OF THE INVENTION

1. Technical Field

The present invention has its application in the field of the use of voice for the access to Digital Contents, such as texts, web pages, movies, documentaries, music, etc.

2. Description of Related Art

Elderly or disabled persons often have difficulties reading texts, either in magazines or books or text retrieved by means of a personal computer from the Internet. Many of these persons do not know how to navigate through the text displayed on a computer screen. Others have such a limited degree of mobility that they simply cannot operate a computer or hold a book. So, many persons cannot enjoy reading. Furthermore, many of these persons do not know or are not able either to navigate the Internet or to perform a search on the Internet. It is estimated that population of disabled people represents 14.5% of the population and a large percentage of these are in the situation previously described.

US patent application US 2008/0114599 A1 discloses a system enabling the reading of text on a screen. Web pages and other text documents displayed on a computer are reformatted to allow a user who has difficulty reading to navigate between and among such documents and to have such documents, or portions of them, read aloud by the computer using a text-to-speech engine in their original or translated form while preserving the original layout of the document. A “point-and-read” paradigm allows a user to cause the text to be read solely by moving a pointing device over graphical icons or text without requiring the user to click on anything in the document. Hyperlink navigation and other program functions are accomplished in a similar manner.

So, this system enables the user to navigate through the text without having to perform mouse clicks. However, the user still has to move a pointer device over the screen for navigating. This may be difficult for elderly people having difficulties in reading and/or understanding graphical icons and/or instruction text on the screen. It may even be impossible for disabled persons with a reduced mobility.

U.S. Pat. No. 5,890,123 discloses a system and method for a voice controlled video screen display system. The voice controlled system is useful for providing “hands-free” navigation through various video screen displays such as the World Wide Web network and interactive television displays. During operation of the system, language models are provided from incoming data in applications such as the World Wide Web network.

U.S. Pat. No. 6,636,831 discloses a system and process for voice-controlled information retrieval. A conversation template is executed. The conversation template includes a script of tagged instructions including voice prompts and information content. A voice command identifying information content to be retrieved is processed. A remote method invocation is sent requesting the identified information content to an applet process associated with a Web browser. The information content is retrieved on the Web browser responsive to the remote method invocation.

U.S. Pat. No. 5,983,184 discloses a system that enables a visually impaired user to control hyper text. A voice synthesis program orally reads hyper text on the Internet. In synchronization with this reading, the system focuses on a link keyword that is most closely related to the location where reading is currently being performed. When an instruction “jump to link destination” is input (by voice or with a key), the program control can jump to the link destination for the link keyword that is being focused on. Further, the reading of only a link keyword can be instructed.

It is an object of the invention to provide a system and a method for enabling users in general, and in particular elderly or disabled users, to navigate through a text or web pages in a user friendly way.

### SUMMARY OF THE INVENTION

According to an aspect of the invention, the use of voice as a means of communication with a computer or programmable device, as well as, converting text to speech, allows visually or physically disabled people access to texts in any format as, but not limited to, newspapers, books, Blogs, or web pages accessible through the Internet or other means of communication with their device or computer, the Device onwards.

Likewise, the invention enables users to access other cultural content such as movies, documentaries, music, etc. We refer to these contents as Cultural Materials and to the group of texts, web pages and Cultural Materials as Digital Contents.

It also allows non-disabled people access to the same, in conditions that prevent them from using their hands, such as driving, or living outside their normal place to live or work, by using the Internet and the Device.

Finally, this invention allows visually impaired users to access the Web exclusively by verbal commands and dictation of words or spelling, making the screen, keyboard and mouse unnecessary.

The ultimate goal of this invention is to provide access to texts, videos, and audio as well as the Web, using voice, and converting text to voice or displaying it through the Device.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a flow chart along with concurrent programs and modules that run on the user's Device to allow users to hear or read texts or other cultural material, as well as to enjoy part of basic services, controlled by verbal commands. It also describes the programmable devices or computers of users.

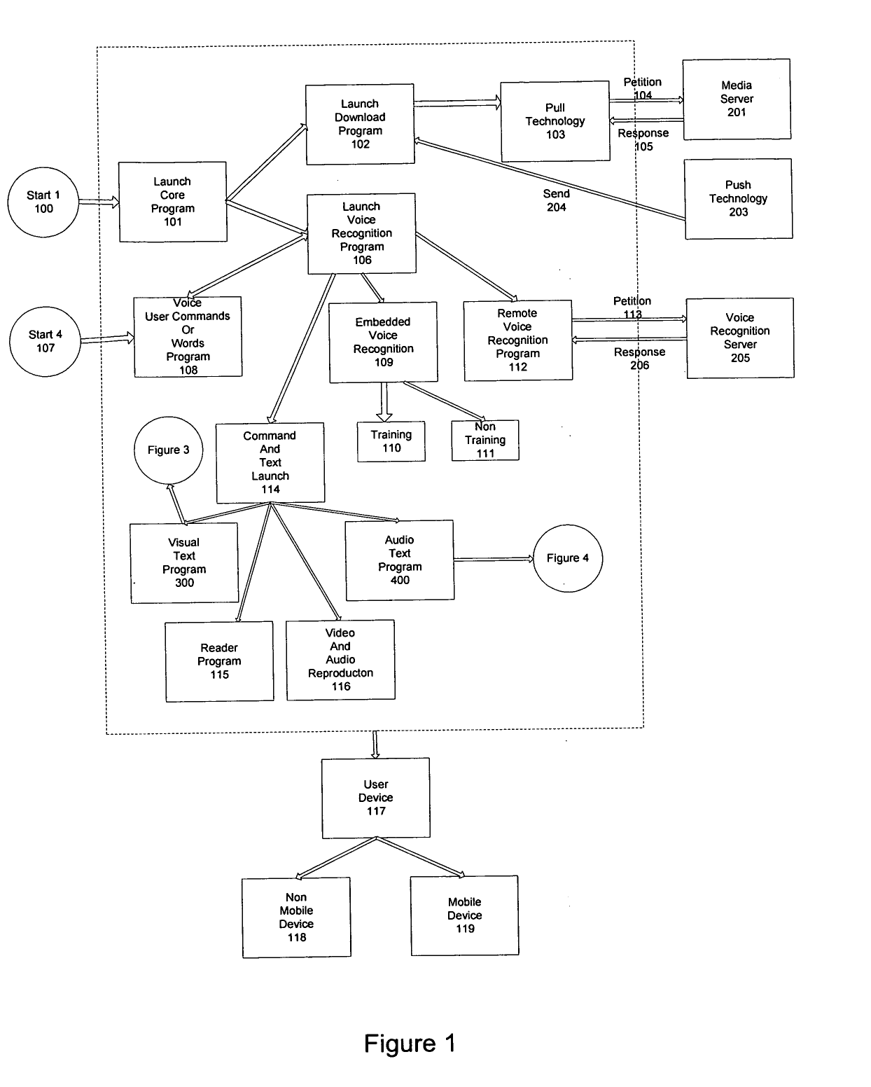

FIG. 2 describes the flowchart along with concurrent programs and modules that run on server computers that access Digital Content, perform functions of speech recognition and text-to-speech conversion.

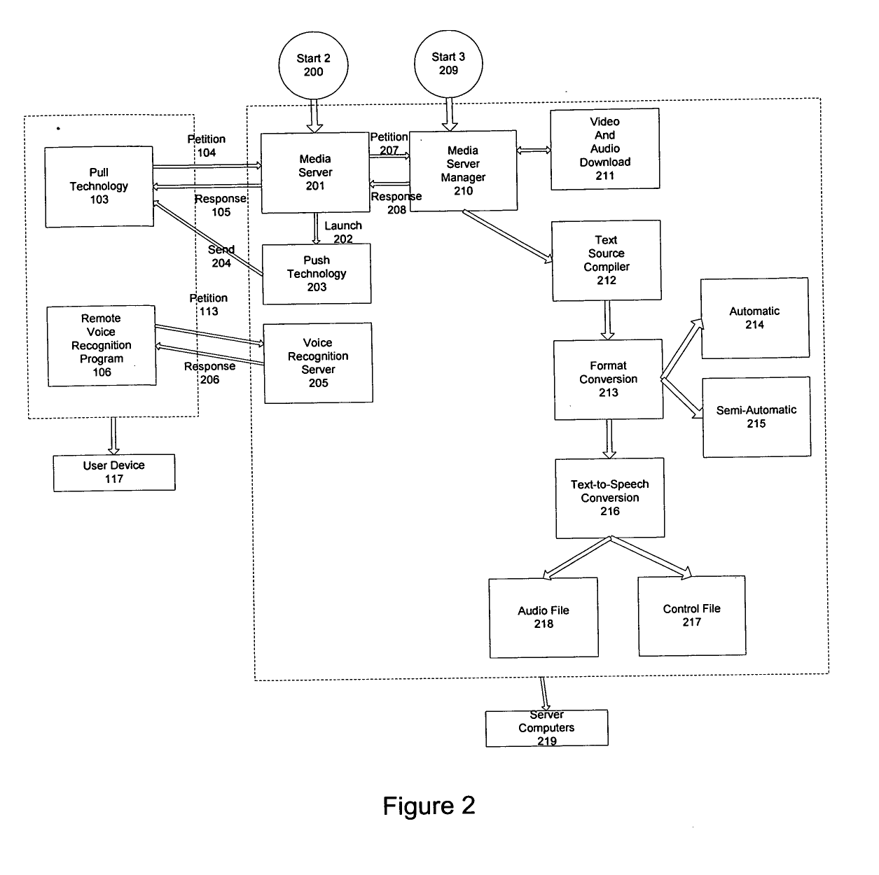

FIG. 3 describes software that enables text display on the user's device and the control of reading through verbal commands.

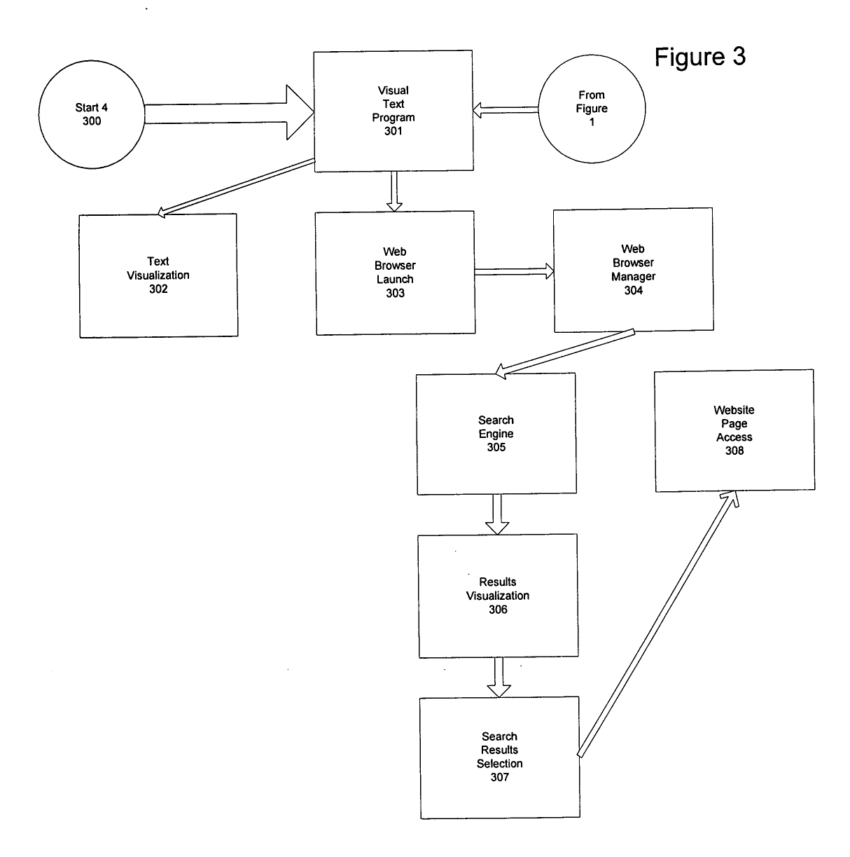

FIG. 4 shows the programs that allow hearing texts of web pages and selecting the pages to hear with the user Device through verbal commands and recognition of words for searching the Internet and selection of pages to listen to.

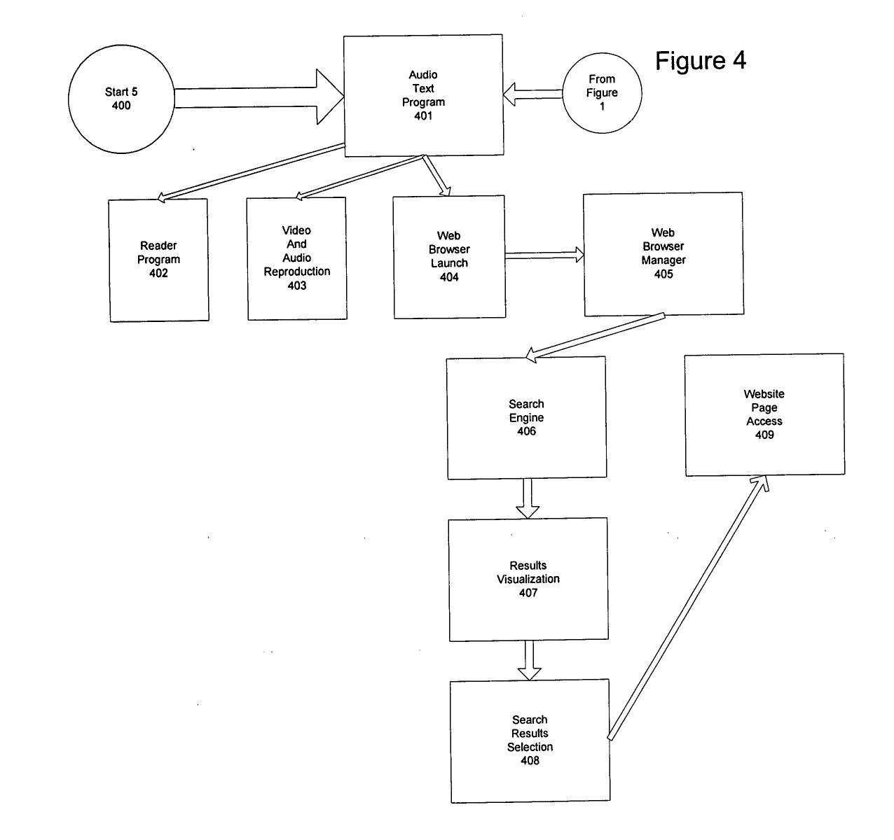

Throughout the figures like reference numerals refer to like elements.

### DETAILED DESCRIPTION OF THE PRESENT INVENTION

a) Overview of Invention

All texts have natural structures that can be used to break them up in individual items and it is also possible to distinguish references to websites by information attached to words, phrases, or direct references to them.

Depending on the type of text, we have basic elements such as, but not limited to, words, phrases, paragraphs, verses, news headlines, prefaces, indices, etc. In the same way, these basic texts can be grouped into more complex units such as, but not limited to, chapters, sections of a newspaper, blogs, etc.

This allows decomposing texts for conversion to voice or display by means of associated files comprising information regarding the location of both the individual basic elements as well as the more complex structures, for reading or listening controlled by verbal commands.

Examples of these verbal commands can be “jump news item”, “page forward”, “go to page of the Internet link”, “watch movie”, etc.

An object of this invention is to allow users to hear or read texts and control the reading or listening by means of these verbal commands on the Device and play Cultural Materials also controlled by verbal commands.

b) Detailed Description (Part One)
(100) Start 1: This is the starting point of the Device when the user turns it on.
(101) Launching the core program. This program runs on the Device and in turn launches programs (102), (106) and (114) operating in parallel and concurrently. When this program is launched, it will start the following three modules:
   The program that accesses the servers to download Digital Content relevant to the user by means of so-called “pull” technology or being pendent of the server sending the content by means of so-called “push” technology.
   The program that is listening to the user. When he gives a verbal command, it will be responsible of recognizing it on the user's Device or by means of the server, so that the server performs the voice recognition and returns what it has recognized. Once the command has been recognized, it will be sent to the program for the reproduction or display of cultural content, so that it will act accordingly.
   The program that reproduces cultural content verbally or that displays it. It will be waiting for commands that the user gives and which will be supplied by the program described above.
(102) Download Program. This program is responsible for downloading texts from the server through one of two technologies: “Pull” (104) or “Push” (203). The pull technology is based on, that it is the user's device who takes the initiative to access the server to ask for the Digital Content of interest to the user. It takes this initiative at certain times of day that have been defined by the user, when a user registered to the service. By contrast, with the push technology, it is the server at certain times, defined by the user that connects to the user's device to inform it that Digital Content is available for the user and that it will send it.
(103) “Pull” Technology. According to this technology the user's device takes the initiative to access the server to download digital content.
(104) This flow represents the request to the server from the device that allows access to digital content desired by the user and stored on the server.
(105) This represents the flow of digital content downloading from the server to the device.
(106) Start of voice recognition software. This program is responsible for recognizing the user's verbal command, words or spelling of other text spoken by the user for various services provided by the invention. It can take place in two ways: (109) and (110). We must distinguish between commands and words or spelling text. The commands trigger a reaction from a program that is playing Digital Content, for example, when the user says “jump” to the program that is reading a story of a newspaper, it skips the news to scroll to the next. On the other hand, recognizing words is necessary to conduct an Internet search using a search engine like Google or Yahoo. Finally, the spelling of text is needed so that a user can dictate the direction or URL of a website, as this is usually not a word of a language. An example would be spelling “meivox.com”.
(107) Start 4. This is the starting point on the device when the user wishes to give a command, dictate a word or spell a text.
(108) This represents the command, words or spelling of text by the user that the speech recognizer must convert to text for processing by the various modules of the invention.
(109) Recognition of embedded voice. The device can perform voice recognition on it autonomously in two ways: (110) and (111). The voice recognition is a program that, when it hears something spoken by a person, it records it and analyzes it to recognize what the user said and converts it to text to be processed by some other program. There are programs in the public domain as PocketSphinx or commercial ones, such as those of the company Nuance. Alternatives to this technology can be user training described below. For the service to surf the Internet, it is necessary in certain situations, for the user to spell a text. More specifically, when the user wants to go to a specific page, normally the address thereof is not a word of a dictionary. Therefore, it will be necessary to spell the URL or Internet address. In this case, voice recognition will be used to recognize each letter, number, or symbol to get the Internet address or URL and then cause the Internet browser go to that page or website.
(110) Voice training. This technology consist in that the user pronounces:
   Commands
   A predefined text, such as “I'm feeling lucky”, one of the buttons offered by the Google search engine.
   The alphabet and numbers or symbols in order to build later texts.
   and the device will record it one or more times to find a pattern that allows more easily to recognize later subsequent verbal commands, words or text, alphabet, numbers or symbols that the user can pronounce.
(111) Without training. This technology allows recognizing the speech pronounced by the user in an untrained manner using a program specifically designed for this in the public domain or a commercial one.
(112) Remote voice recognition. The device records the user's words uttered and sends them to the server where they are recognized the text is then returned to the device.
(113) This information flow corresponds to the sending of the recording of the user's words uttered by the user that are sent to the server for recognition.
(114) Launching the control program for commands and word processing. The recognizer receives the voice commands, words or letters and numbers delivered by the user and is responsible for:
   Giving commands to the text reader (115)
   Giving commands to the player of Cultural Material (116)
   Giving commands to display text (300)
   Give commands, words or letters, numbers or symbols to the program for hearing Web texts (400)
(115) Text Reader. This program is responsible for playing audio files downloaded from the server and act in accordance with the orders received from the commands and word processing control program (114). Part of the invention is the reading by hearing the spoken text or by displaying it on the screen with voice control. This module or program is responsible for speaking the texts. Effectively, this feature is the result of the fact that any text, whether a newspaper, magazine, book, etc., has an organization and some concepts (paragraphs, news, chapters, etc.) and that, based on this, we can define the most suitable commands to “read” aurally. When a user wants to “read” a newspaper, he gives an order to start reading and begins to hear the text. From this moment, he can give orders to move forward, backward, pause, and so on, according to his needs or interests. For example, if he is listening to the International section of a newspaper and no longer wants to continue with this section, he can say, “jump” and the text reproduction passes to the next section. On the other hand, he can say, “repeat” to re-hear the latest news. This reproduction takes into account the structure so that if one is hearing the latest news of a section of a newspaper and requests the program to jump, it will proceed to the next section or if it is the last section, it will tell the user that he has finished and it will ask if he wants to delete or keep the newspaper for later re-read. The way to carry out this functionality is based on a control file associated with the newspaper or book which indicates at which time (second) of the overall content of the spoken text each basic component, news, paragraph, verse, blog entry, etc., is located as well as the locations of higher structures, for example among others, sections of a newspaper or chapters of a book. Alternatively, marks can be embedded in the voice files to know the beginning of each component or structure.
(116) Playing Cultural Material. This program is responsible for reproducing the Cultural Materials downloaded from the server and act in accordance with the orders received from the control program commands and word processing (114). In the same way as in the case of hearing the text reproduction, audiovisual material can also be controlled. The invention provides the same functionality that playback devices usually provide: to advance a segment, for example, a song from a list of songs or fast forward/or rewind a video and choosing the rate thereof. However, some videos, like for example those in the TV series, have created disruptions at the time of recording to allow introducing ads. These interruptions can be detected and can be used to move forward or backward depending on the user's desire.
(117) User device. This reference covers all devices that users can use: (118) and (119).
(118) Non-mobile devices. These devices are, but not limited to, the following: computers, electronic book readers, interactive televisions, video games consoles, audio and video players, PDAs (Digital Assistants), telephones, etc. with access to the Internet via modem connection, cable, DSL, telephone or other means.
(119) Mobile Devices. These devices are those with wireless Internet access, such as but not limited to: computers, electronic book readers, interactive televisions, video games consoles, audio and video players, PDAs (Digital Assistants), telephones, etc. with wireless Internet access, as Wi-Fi, WiMAX, DoCoMo, WLAN, telephone systems (0G, 1G, 3G, 3.5G, 4G), Bluetooth and so on and others that exist or may exist in the future.

c) Detailed Description (Part Two)
(200) Start 2: This is the starting point on the Server for the communication services with the Device for dispatching of Digital Content.
(201) This program is the one that communicates with the device for sending the Digital Content.
(202) This flow represents communication with the program that implements the Push technology (203)
(203) Push Technology. This program is responsible for sending the Digital Content to the Device on the server's initiative.
(204) This represents the flow of Digital Content to the Device sent from the server by its' initiative.
(205) This program is responsible for the recognition of commands, words, letters, numbers or symbols recorded by the user's device for recognition by the server. It receives an audio file and returns the recognized text.
(206) This flow is the text recognized by the server.
(207) This flow is the request to the Digital Content Server of interest to the user and picked up by Media Server Manager.
(208) This flow is the Digital Content that the server sends to the user's device.
(209) Start 3: This is the starting point on the Media Server Manager, which is responsible for collecting the Digital Content of interest to the user.
(210) This program is the Media Server Manager. It is responsible for collecting the Digital Content of interest to the user.
(211) This program is responsible for downloading Cultural Materials from websites that are of interest to the user. The user can, using an Internet browser, select Cultural Materials that can be downloaded giving the source thereof or they can be selected from a Database of Cultural Resources. This database contains references to cultural material, that is available for free or for a fee, with description of its contents, and categories (i.e. adventure, biography, etc.) and opinions of others who have accessed it previously.
(212) This program is responsible for downloading texts, such as books and newspapers, among others, from websites, which are of interest to the user. As in the previous case, the user may consult the Database of Cultural Resources to select what is of his interest. He can also define a composed newspaper or press with blogs and sections from different sources, and even in different languages, frequency and time or day of closure of the edition. The contents may be paid by subscription or single payment or by using RSS of the press. RSS is a simple data format that is used for spreading contents to subscribers of a website.
(213) This conversion program formats the texts for later conversion into voice.
(214) This program automatically converts texts for which this is possible into a format that allows later conversion into voice.
(215) This program converts text semi-automatically in a format that allows its conversion to voice through assistance of a person in the format conversion process.
(216) Program for converting text-to-speech. It may create one single file or multiple files for a text.
(217) This box represents a file or files associated with audio files of text converted to voice, enabling subsequent reproduction (playing) thereof, so that this hearing can be controlled by voice commands, that may optionally be created. It contains the necessary information to manipulate the hearing in accordance with the wishes of the user represented by the commands. The exact content is the starting time (second) of each basic element, such as news, paragraph, verse, and so on within the overall content of the text. It also contains the starting second of each grouping of basic elements or compounds, for example a section of a newspaper, a blog, chapter, etc. In the case of books, they may have, for example, an index that may be consulted in order to select the chapter or story and/or story (in the case of being a compilation of several) the user wishes to access.
(218) This box represents the file or files of the texts converted to voice that subsequently will be reproduced (played) for the user.
(219) This box represents the servers or computers that perform all the functions described in paragraphs (200) to (218).
The conversion of the text into voice performed by the programs and modules shown by references 213-219 may of course also be performed by the user device 117. In this case the server transmits the text to the user device and a program in the user device converts the text into voice while the user is listening. Alternatively, the text-to-voice conversion takes place previously and the user listens to the voice later on. According to a further alternative embodiment, the text is converted to voice at the server and sent to the user device in real time (streaming).

d) Detailed Description (Part Three)
(300) Start 5: This is the start of the user's Visual Text display services.
(301) Program Viewing Texts. This program brings together the programs Viewing Texts (302) and the initialization of Internet browsers (303).
(302) This program is responsible for displaying the texts chosen by the user so that it can control their reading through verbal commands like “Advance page,” “Skip to chapter 3”, etc.
(303) This program is responsible for initiating an Internet browser.
(304) This program allows the user to initiate an Internet search engine or go to a specific page through interpretation of a user's verbal command and in the case of going to an Internet page, after recognizing the address given verbally by the spelling of the URL, the page is shown.
(305) This program starts the internet search engine requested by the user and asks him to dictate the keywords that he wants to search.
(306) This program is responsible for displaying the contents of the search result requested by the user.
(307) This program allows the user to select the page he wants from those found by the selection made by the user.
(308) This program allows the user to navigate through the website directly or through the Internet browser by means of the recognition of the commands of the user regarding displayed link on the page or pages of the website.

e) Detailed Description (Part Four)
(400) Start 6: This is the starting point of Representing Text by Sound services for the user. This set of modules allows blind users to listen texts and surf the Internet exclusively using verbal commands, dictating words and spelling texts that are web addresses or URLs.
(401) Program of Hearing Texts. This program brings together the programs Reading Texts (402), the reproduction of Cultural Materials (403) and the initialization of Internet browsers (404).
(402) This program is responsible for reading the texts chosen by the user so that it can control their reading through verbal commands like “Advance chapter”, “See the index”, etc.
(403) Playing video and audio. This program is responsible for playing the video and audio files chosen by the user
(404) This program is responsible for initiating an Internet browser.
(405) This program allows the user to initiate an Internet search engine or go to a specific page through interpretation of a user's verbal command and in the case to going to an Internet page, after recognizing the address given verbally by the spelling of the URL, read it.
(406) This program starts page internet browser requested by the user and asks him to dictate the keywords with which he wants to do the search.
(407) This program is responsible for reading the contents of the search result requested by the user
(408) This program allows the user to select the page he wants from those found with the selection made by the user by reading the different pages that have been found as a result of the search.
(409) This program allows the user to navigate through the website directly or through selected Internet browser by reading the page and using a different tone or reading level on the links in the page or pages of the website.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. System for reading text by voice control, comprising:
voice recognizer for recognizing verbal commands of the user,
a downloader for downloading the text,
a text reader for reproducing the text on a user device, wherein the text has a structure that comprises basic elements and higher layer groups of the basic elements, wherein based on a control file associated to the text, in which the location of each basic element as well as the location of the higher layer groups is indicated, the user is enabled to control by means of voice commands, which of the basic elements or higher layer groups is reproduced by the reader.

2. System according to claim 1, wherein the text reader reproduces the text on a display.

3. System according to claim 1, further comprising a converter for converting text to voice and the text reader reproducing the voice.

4. System according to claim 1, further being adapted for reproducing audiovisual material by voice control, comprising:
a downloader for downloading the audiovisual material and
an audio and video player for reproducing the audiovisual material.

5. System according to claim 1, wherein the voice recognizer recognizes the spelling of letters, numbers and/or symbols and concatenates them until obtaining an Internet address or URL, the system furthermore comprising an Internet browser for going to the corresponding page or website.

6. System according to claim 5, wherein the Internet browser initiates an Internet search engine based on a user request and the voice recognizer recognizes keywords to be searched dictated by the user.

7. System according to claim 6, further comprising means for providing the user with the result of the search requested by the user and a selector for enabling the user to select from the pages found, the page that the user wishes to access.

8. System for browsing to an Internet page or website, comprising:
a voice recognizer for recognizing the spelling of letters, numbers and/or symbols by a user and concatenating them until obtaining an Internet address or URL, and
an Internet browser for browsing to the corresponding page or website.

9. System according to claim 8, wherein the Internet browser initiates an Internet search engine based on a user request and the voice recognizer recognizes keywords to be searched dictated by the user.

10. System according to claim 9, further comprising means for providing the user with the result of the search requested by the user and a selector for enabling the user to select from the pages found, the page that the user wishes to access.

11. System for initiating an Internet search comprising:
an Internet browser for initiating an Internet search engine based on a user request, and
a voice recognizer for recognizing keywords to be searched dictated by the user.

12. System according to claim 11, further comprising means for providing the user with the result of the search requested by the user and a selector for enabling the user to select from the pages found, the page that the user wishes to access.

13. Method for reading text by voice control, comprising the steps of:
recognizing verbal commands of the user,
downloading the text,
reproducing the text on a user device, wherein the text has a structure that comprises basic elements and higher layer groups of the basic elements, wherein based on a control file associated to the text, in which the location of each basic element as well as the location of the higher layer groups is indicated, it is controlled by means of voice commands of the user, which of the basic elements or higher layer groups is reproduced by the reader.

14. Method for browsing to an Internet page or website, comprising the steps of:
recognizing the spelling of letters, numbers and/or symbols by a user and concatenating them until obtaining an Internet address or URL, and
browsing to the corresponding page or website.

15. Method initiating an Internet search comprising the steps of:
initiating an Internet search engine based on a user request, and
recognizing keywords to be searched dictated by the user.

16. A computer program comprising computer program code means adapted to perform the steps of claim 12, when said program is run on a computer.
